(19) United States
(12) Patent Application Publication
(10) Pub. No.: US 2024/0124289 A1
(43) Pub. Date: Apr. 18, 2024

(54) Beverage preparation machine having a drive, and beverage preparation system

(71) Applicant: Freezio AG, Amriswil (CH)

(72) Inventor: Gabriel Stösser, Langrickenbach (CH)

(21) Appl. No.: 18/278,244

(22) PCT Filed: Mar. 11, 2022
(86) PCT No.: PCT/EP2022/056327

§ 371 Date: Aug. 22, 2023

(30) Foreign Application Priority Data
Mar. 11, 2021 (DE) 10 2021 202 399.1

(51) Int. Cl. B67D 1/00

(52) U.S. Cl. CPC B67D 1/0021; B67D 1/0079; B67D 2001/0812

(57) ABSTRACT

The invention relates to a beverage preparation machine (1) for preparing a beverage by means of a cartridge system consisting of a cartridge (7), which has a beverage substance in a reservoir (8), and of a cartridge receptacle (11) which is connected to the cartridge (7) and has a mixing chamber, at least one fluid supply and a beverage outlet, wherein the beverage preparation machine (1) comprises a main unit (2) and a cartridge holder (3) which protrudes from the main unit (2) and is in particular designed like a balcony, wherein the cartridge holder (3) is designed such that the cartridge system can be inserted into it, wherein the cartridge holder (3) comprises an actuator element (14) for operating a cartridge discharging device of the cartridge system, wherein the main unit (2) comprises a liquid reservoir (4), a liquid conditioning system for conditioning a liquid from the liquid reservoir (4), in particular for controlling the temperature of and/or carbonating the liquid, a fluid supply system for introducing the conditioned liquid and/or pressurised air into the cartridge system, and a control device for controlling the liquid conditioning system and/or the fluid supply system, wherein the main unit (2) and/or the cartridge holder (3) comprises a drive for the actuator element (14).

### PRIOR ART

The invention relates to a beverage preparation machine, in particular a dispenser, for preparing a beverage by means of a cartridge system consisting of a cartridge, which has a beverage substance in a reservoir, and of a cartridge receptacle, which is connected to the cartridge and has a mixing chamber, at least one fluid supply and one beverage outlet.

Dispensers of this kind are known in principle from the prior art, for example from EP 2 017 221 A1 and WO 96/36556 A1, and are used for the production of beverages from preportioned cartridges. The production of beverages with such cartridge systems is extremely convenient for users since they have only to insert a cartridge into the dispenser and initiate a starting procedure. The dispenser then takes over the production of the beverage in a fully automated manner, that is to say in particular that the food or beverage substrate is mixed with a predetermined amount of liquid, in particular cold and carbonated water, and is passed into a drinking vessel. In this way, it is possible, in particular, to produce mixed beverages significantly more easily, more quickly and with less effort for users. Users can choose from a multiplicity of different cartridges, enabling them to produce different beverages as desired.

In this case, the beverage preparation machine or dispenser comprises a main unit and a cartridge holder, which protrudes from the main unit, wherein the cartridge holder is designed in such a way that the cartridge system can be inserted into it, wherein the cartridge holder comprises an actuator element for actuating a cartridge discharging device of the cartridge system. Owing to the protruding cartridge holder, the actuation of the actuator element is mechanically difficult to implement since the cartridge holder generally has little installation space, especially for movable elements. The mechanism for actuating the actuator element must be of simple construction and must interact reliably with the changing cartridge receptacles of the cartridge system. However, no suitable solutions for this purpose have hitherto been known from the prior art.

### DISCLOSURE OF THE INVENTION

It was therefore the object of the present invention to make available a beverage preparation machine which meets these requirements. In particular, simple and reliable actuation of the actuator element is to be made possible. At the same time, the dispenser should be very convenient to operate and should be capable of being implemented at low cost.

The object is achieved, inter alia, with a beverage preparation machine as per claim 1.

The statements pertaining to this subject matter of the present invention also apply equally to the other subjects of the present invention and vice versa.

The present invention relates to a beverage preparation machine, in particular a dispenser, for preparing a beverage by means of a cartridge system. A cartridge system of this kind, provided for use in the beverage preparation machine according to the invention, consists of a cartridge, which has a beverage substance in a reservoir, and of a cartridge receptacle, which is connected to the cartridge and has a mixing chamber, at least one fluid supply and one beverage outlet. The cartridge receptacle is preferably fixedly, in particular non-rotatably, connected to the cartridge in a connecting region. The cartridge has a cartridge opening, which is particularly preferably closed by means of a sealing element, for example a sealing film, and is thereby fluidically separated from the mixing chamber. In order to transfer the beverage substance into the mixing chamber for beverage preparation, the cartridge receptacle comprises a cartridge discharging device, which preferably comprises a displaceable piercing spike, which can penetrate the sealing film and thereby establishes a fluid connection between the reservoir and the mixing chamber.

The beverage preparation machine comprises a main unit, which preferably comprises a housing, and a cartridge holder, which protrudes from the main unit and is, in particular, of balcony-like design. Balcony-like in this case preferably means that the cartridge holder projects laterally out of the housing, that is to say in particular is not arranged in the housing of the main unit but is formed separately therefrom. The main unit further comprises at least one liquid reservoir, a liquid conditioning system for conditioning a liquid from the liquid reservoir, in particular for controlling the temperature of and/or carbonating the liquid, a fluid supply system for introducing the conditioned liquid and/or compressed air into the cartridge system, and a control device for controlling the liquid conditioning system and/or the fluid supply system. As a particular preference, the liquid conditioning system and the fluid supply system, in particular, are arranged at least partially in the housing of the main unit. As a particular preference, the main unit and/or the cartridge holder have/has at least one operating element, by means of which a user can initiate a beverage preparation process.

The cartridge holder is now designed in such a way that the cartridge system can be inserted into the cartridge holder, in particular in such a way that the cartridge system is held reversibly by the cartridge holder, wherein the cartridge holder comprises an actuator element for actuating a cartridge discharging device of the cartridge system. The actuator element preferably comprises a movable element which, for example, when activated, contacts and displaces the piercing spike in such a way that the latter pierces the sealing element, thus allowing the beverage substance to be transferred from the reservoir into the mixing chamber.

According to the invention, it is now envisaged that the main unit and/or the cartridge holder comprise/comprises a drive for the actuator element. The drive is preferably a manual drive and/or a motor, wherein the drive is, in particular, a linear drive, a rotary drive and/or a vibratory drive. By means of the drive, simple and reliable activation of the actuator element is made possible in a particularly advantageous manner. In addition, the drive makes it possible, particularly in the case of a manual drive, to reduce the force to be applied by the user to actuate the cartridge discharging device. In this context, a manual drive is to be understood, in particular, to mean that the user moves the actuator element directly or indirectly. If the user does not actuate the actuator element directly, they move at least one operating element in such a way that the movement leads, in particular purely mechanically, to a movement of the actuator element. If the drive is a motor, particularly convenient operation of the beverage preparation machine is made possible in a particularly advantageous manner. For example, the user has only to insert the cartridge system into the cartridge holder and actuate an operating element, whereupon the beverage preparation machine starts and/or carries out the process of beverage preparation fully automatically. The control device is preferably also provided for controlling the drive, in particular the motor. In this case, the control device is particularly preferably provided to activate the motor and thus to actuate the actuator element. This advantageously makes it possible to better control the process and thus enable error-free beverage preparation since the control device can optimally determine the time of activation of the cartridge discharging device, in particular with regard to the conditioning and introduction of the liquid. By virtue of the fact that the control device can determine the time of activation of the cartridge discharging device, optimized control of all components is possible. In particular, it is possible in a particularly advantageous manner to prevent beverage substance from entering lines of the beverage preparation machine and contaminating the latter and/or to prevent beverage substance from exiting too early, i.e. possibly exiting from the cartridge system without mixing with the liquid. Moreover, it is possible to generate higher forces than those which can occur when the actuator element is actuated directly by a user, it being possible, in particular, to generate forces of up to 30 N by means of a drive.

According to a preferred embodiment, it is envisaged that the motor is an electric motor, a hydraulic motor or a pneumatic motor. The beverage preparation machine preferably comprises a connection to an external energy supply and/or an internal energy store, for example an accumulator. An electric motor can therefore advantageously be supplied with energy by the same source as the other components of the beverage preparation machine. In the case of a pneumatic motor, air from an internal or external compressed air source, for example, can be used as operating medium. This makes the beverage preparation machine particularly flexible and efficient in its design.

According to a preferred embodiment, it is envisaged that the cartridge holder is of substantially disk-shaped design and preferably protrudes substantially horizontally from the main unit, wherein, as a particular preference, the cartridge holder has a, in particular substantially circular, aperture into which the cartridge system can be inserted. As a very particular preference, a set-down region for drinking vessels is provided below the cartridge holder, wherein the set-down region comprises, in particular, a liquid collecting device. By virtue of the disk-shaped design of the cartridge holder, an optically appealing cartridge holder is provided, which requires little installation space. The relative orientation of the cartridge holder, in particular of the aperture, and the set-down region make it possible for the beverage to flow directly from the cartridge receptacle of the cartridge system into the drinking vessel. As a particular preference, the position of the cartridge holder from a support surface of the beverage preparation machine is arranged at a height which corresponds to 20-90% of the total height of the beverage preparation machine, very particularly preferably 40-80%, even more preferably 50-70% and, in particular, substantially 60%.

According to a preferred embodiment, it is envisaged that the beverage preparation machine, in particular the cartridge holder and/or the main unit, has at least one operating element which can be actuated by a user and is coupled to the drive, in particular via the control device. Provision is preferably made for the operating element to be a lever, which can be pivoted, in particular about a horizontally or vertically oriented axis. A lever represents a particularly simple and proven variant which can be operated intuitively by a user and, where applicable, can have a force-multiplying effect via a corresponding mechanism, with the result that the user only has to apply a slight force and the actuator element nevertheless reliably actuates the cartridge discharging device.

According to a preferred embodiment, it is envisaged that the cartridge holder has at least one locking means, which is provided for reversibly locking the cartridge system in the cartridge holder, wherein the locking means can be transferred from an unlocked position into a locked position and vice versa. The locking means can preferably be transferred from the unlocked position into the locked position by the operating element. As a particular preference, the operating element comprises a hand lever. Such a hand lever can be pivoted, by a user for example, about a vertical axis, preferably in an angular range of 10 to 180 degrees, particularly preferably in an angular range of 40-120 degrees, in particular in an angular range of approximately 90 degrees. The user inserts the cartridge system into the cartridge holder and actuates the hand lever, whereby the locking means is transferred into the locked position. The angular positions of the hand lever advantageously make it easy for the user to see whether the locking means is in the locked or the unlocked position.

According to a preferred embodiment, it is envisaged that the beverage preparation machine, in particular the control device, is configured in such a way that the actuator element and/or the drive can only be activated when the locking element is in the locked position. In this way, damage to the beverage preparation machine is advantageously avoided. As a particular preference, the locking element can be transferred into the locked position only if the cartridge system is inserted correctly. This ensures the liquid being able to pass correctly into the cartridge receptacle and the actuator element being arranged relative to the cartridge discharging device in such a way that correct actuation of the latter is possible.

According to a preferred embodiment, it is envisaged that the drive is connected to the actuator element via a deflection mechanism, wherein the deflection mechanism preferably comprises a transmission gear and/or a transmission lever. As a result, it is advantageously possible, on the one hand, for the position and direction of movement of the drive to be largely independent of the position and direction of movement of the actuator element, thereby allowing more flexible positioning of the drive, and, on the other hand, for a force multiplication to be implemented, thus allowing the drive to be dimensioned to be smaller than would be necessary for direct actuation of the actuator element and/or of the cartridge discharging device. The deflection mechanism, in particular the transmission gear, is preferably provided in such a way that a rotational movement of the hand lever about the vertical axis of rotation is converted into a relative translational movement of the actuator element and/or of the cartridge receptacle.

According to a preferred embodiment, it is envisaged that the actuator element is provided so as to be pivotable about at least one, in particular horizontally arranged, axis. The axis is preferably arranged in such a way that the actuator element performs a substantially circular arc-shaped movement to actuate the cartridge discharging device, this movement taking place, in particular, substantially in a vertical direction. As a very particular preference, the axis is arranged in the vicinity of the transition between the main unit and the cartridge holder. This advantageously enables activation of the actuator element despite the small installation space available in the cartridge holder.

According to a preferred embodiment, it is envisaged that the actuator element is arranged at least partially below the cartridge holder. This is particularly advantageous if the cartridge system is inserted into the cartridge holder from above in such a way that the cartridge discharging device is accessible from below the cartridge holder. In addition, the underside of the cartridge holder is generally not visible to the user when the beverage preparation machine is positioned in the usual way, and therefore arranging the actuator element on the underside of the cartridge holder imparts a tidy overall appearance to the beverage preparation machine.

According to a preferred embodiment, it is envisaged that the actuator element is a rocker lever, wherein the rocker lever has an upper contact surface for positive and/or nonpositive interaction with the cartridge discharging device of the cartridge system. The rocker lever preferably extends substantially longitudinally, in particular being of substantially rod-shaped design. In particular, if the tilting axis of the rocker lever is provided on the underside of the cartridge holder, the actuator element can thus be arranged at least partially on the underside of the cartridge holder, while the drive can be arranged in the main unit.

According to a preferred embodiment, it is envisaged that the beverage preparation machine comprises a compressed air source, wherein the compressed air source is provided for introducing compressed air into the cartridge system in interaction with the fluid supply system. The beverage preparation machine preferably has a compressed air source arranged within the main unit. Alternatively or additionally, it is envisaged that the beverage preparation machine can be connected to an external compressed air supply. As a particular preference, the beverage preparation machine has a coupling element, wherein the coupling element has a compressed air line and a liquid line, wherein the coupling element can be coupled very particularly preferably reversibly to the fluid supply of the cartridge receptacle. This advantageously makes it possible for compressed air and liquid to be fed into the cartridge system simultaneously in a reliable and reproducible manner. During this process, the compressed air is preferably introduced into the reservoir in order to transfer the beverage substance into the mixing chamber, where it mixes with the liquid introduced into the mixing chamber and, in particular, conditioned, and the beverage is thus produced. In particular, the coupling element ensures parallel and fluidically separated feeding of compressed air and liquid into the cartridge receptacle.

According to a preferred embodiment, it is envisaged that the beverage preparation machine, in particular the main unit, has an identification detector for detecting an identification of the cartridge system. As a particular preference, the identification detector is arranged at least partially above and/or behind the cartridge holder. As a very particular preference, the identification detector is arranged in a housing of the main unit. Even more preferably, the identification detector is connected to the control device. It is thereby possible in a particularly advantageous manner for an identification of the cartridge system to be read out, in particular after fastening in the cartridge holder, and for control of the beverage preparation machine to take place in accordance with the detected information. For example, it can be provided that a beverage preparation process can only be started when positive identification information is read out and transmitted to the control device. Alternatively or additionally, it is conceivable for the identification detector to detect at least one parameter for beverage preparation and to transmit it to the control device, wherein the control device preferably controls the beverage preparation process, in particular the liquid conditioning system and/or the fluid supply system, in accordance with the detected parameters. As a very particular preference, the identification detector has an optical sensor, such as a CCD camera, which automatically reads out the identification, in particular the product identification code, when the cartridge system is inserted into the beverage preparation machine. Alternatively or additionally, the identification detector has a magnetic and/or electric sensor. It is furthermore possible for the beverage preparation machine to comprise a communication module in order to receive information relating to beverage preparation and/or the cartridge system and to make it available to the control device. Alternatively or additionally, the identification detector comprises a transmitting and receiving antenna for automatically reading out, for example, an RFID code.

The present invention furthermore relates to a beverage preparation system having a beverage preparation machine according to the invention and a cartridge system, wherein the cartridge system can be inserted into the cartridge holder of the beverage preparation machine for beverage preparation, wherein the cartridge system comprises a cartridge, which comprises a reservoir filled with a beverage substance, and a cartridge receptacle, which can be connected to the cartridge in a connecting region, wherein the cartridge has a cartridge opening, wherein the cartridge opening is closed by a sealing element, in particular a sealing film, wherein the sealing element closes off the reservoir in a fluidtight manner with respect to the cartridge receptacle, wherein the cartridge receptacle has a mixing chamber, which can be brought into fluid communication with the reservoir, and a fluid supply, which opens into the mixing chamber, for coupling to the fluid supply system of the beverage preparation machine, thus enabling a conditioned liquid to be introduced into the mixing chamber, wherein the cartridge receptacle has a cartridge discharging device for transferring the beverage substance from the reservoir into the mixing chamber, wherein the cartridge receptacle has a beverage outlet for dispensing from the mixing chamber a beverage formed by mixing the liquid with the beverage substance. In this case, as a particular preference, the beverage is dispensed directly into a drinking vessel. The cartridge discharging device preferably further comprises a compressed air supply, which is provided for interaction with the fluid supply system, in particular with the coupling element, of the beverage preparation machine, in order to introduce compressed air into the reservoir through the cartridge discharging device.

The statements pertaining to this subject matter of the present invention also apply equally to the other subjects of the present invention and vice versa.

Such a beverage preparation system is particularly advantageous since contamination of the beverage preparation machine with the beverage substance is avoided. Only a conditioned liquid is fed into the mixing chamber of the cartridge receptacle, and preferably compressed air, beverage preparation takes place completely in the mixing chamber, and the finished beverage is discharged directly from the cartridge system into the drinking vessel arranged below without any contact with the beverage preparation machine. Such a beverage preparation system therefore meets the highest hygiene requirements. In addition, the drive means that beverage preparation is accomplished in a particularly simple and reliable manner.

According to a preferred embodiment, it is envisaged that the cartridge discharging device comprises a spike guide and a piercing spike, which is mounted so as to be displaceable within the spike guide, in particular in one direction, wherein the piercing spike is displaceable by the actuator element of the beverage preparation machine between a retracted position, in which the piercing spike is at a distance from the sealing element, and an extended position, in which the piercing spike pierces the sealing element and projects into the reservoir. In this case, the piercing spike and the actuator element are preferably designed in such a way that reliable displacement of the piercing spike by the actuator element is ensured. This can be achieved, for example, if the piercing spike has, on the side facing the actuator element, a concave surface, in which a convex surface of the actuator element engages, or vice versa. Such a piercing spike is a particularly simple and reliable embodiment of a cartridge discharging device. The spike guide ensures reliable movement of the piercing spike.

According to a preferred embodiment, it is envisaged that the cartridge discharging device comprises a compressed air connection and a compressed air line, which extends from the compressed air connection to a compressed air outlet, wherein the compressed air outlet protrudes, in particular in the direction of the reservoir of the cartridge, wherein the compressed air connection is designed to introduce compressed air into the compressed air line, wherein the compressed air line is integrated into the piercing spike, wherein the cartridge discharging device is designed in such a way that, in the extended position of the piercing spike, the beverage substance can be transferred from the reservoir into the mixing chamber by the compressed air. It is thus possible, in particular, for the compressed air to be introduced into the compressed air line from the fluid supply system only in the extended position of the piercing spike. Premature introduction of compressed air is thereby advantageously avoided. Moreover, in the extended position, the compressed air can be introduced selectively into the reservoir and thus contributes to avoiding a reduced pressure resulting from the transfer of the beverage substance into the mixing chamber and/or to actively expelling the beverage substance from the reservoir.

The present invention furthermore relates to a method for preparing a beverage with a beverage preparation system according to the invention, characterized by the following steps:
inserting a cartridge system consisting of a cartridge and a cartridge receptacle into the cartridge holder,
establishing a fluid connection between the fluid supply system and the cartridge receptacle,
activating the actuator element to actuate the cartridge discharging device, in particular by transferring the piercing spike from the retracted position into the extended position, thereby bringing about perforation of the sealing element,
transferring the beverage substance from the reservoir of the cartridge into the mixing chamber of the cartridge receptacle, in particular by feeding compressed air into the reservoir,
introducing a conditioned liquid into the mixing chamber of the cartridge receptacle through the fluid supply system, and
discharging the beverage produced in the mixing chamber by mixing the beverage substance with the conditioned liquid through the beverage outlet.

The statements pertaining to this subject matter of the present invention also apply equally to the other subjects of the present invention and vice versa.

The method according to the invention is distinguished from known methods in that the step of activating the actuator element includes activating the drive. This advantageously ensures that the beverage preparation process can be controlled in an optimum manner and, in particular, that actuation of the cartridge discharging device takes place in a reliable and simple manner.

According to a preferred embodiment, it is envisaged that activating the actuator element comprises generating a relative movement between the cartridge receptacle and the actuator element, which is, in particular, in contact with the piercing spike. The cartridge system is preferably inserted into the cartridge holder in such a way that there is contact between the piercing spike and the actuator element. Alternatively, contact is only produced by activating the actuator element. As a very particular preference, the cartridge receptacle remains immobile during beverage preparation, and the actuator element is moved along a predetermined trajectory. Alternatively or additionally, however, the cartridge receptacle and, in particular, the cartridge holder together with the cartridge system are also moved in the direction of the actuator element.

### DESCRIPTION OF THE FIGURES

In the following, the invention is explained with reference to FIGS. 1 to 11. These explanations are merely by way of example and do not restrict the general concept according to the invention. The explanations apply equally to the beverage preparation machine according to the invention, the beverage preparation system according to the invention and the method according to the invention.

FIG. 1 shows a beverage preparation machine according to a first exemplary embodiment of the present invention.

FIG. 2 shows a cross section of a beverage preparation system according to one exemplary embodiment of the present invention.

FIG. 3 shows a perspective view of a cartridge holder according to one exemplary embodiment of the present invention.

FIG. 4 shows a perspective sectional view of a cartridge holder according to one exemplary embodiment of the present invention.

FIGS. 5-7 show a method for preparing beverages according to one exemplary embodiment of the present invention in various steps.

FIG. 8 shows a schematic cross section of a cartridge holder and an actuator element according to one exemplary embodiment of the present invention.

FIG. 9 shows a perspective view of an actuator element and a drive according to a further exemplary embodiment of the present invention.

FIG. 10 shows a perspective view of an actuator element and a drive according to yet another exemplary embodiment of the present invention.

FIG. 11a, b show perspective views of an actuator element according to a further exemplary embodiment of the present invention.

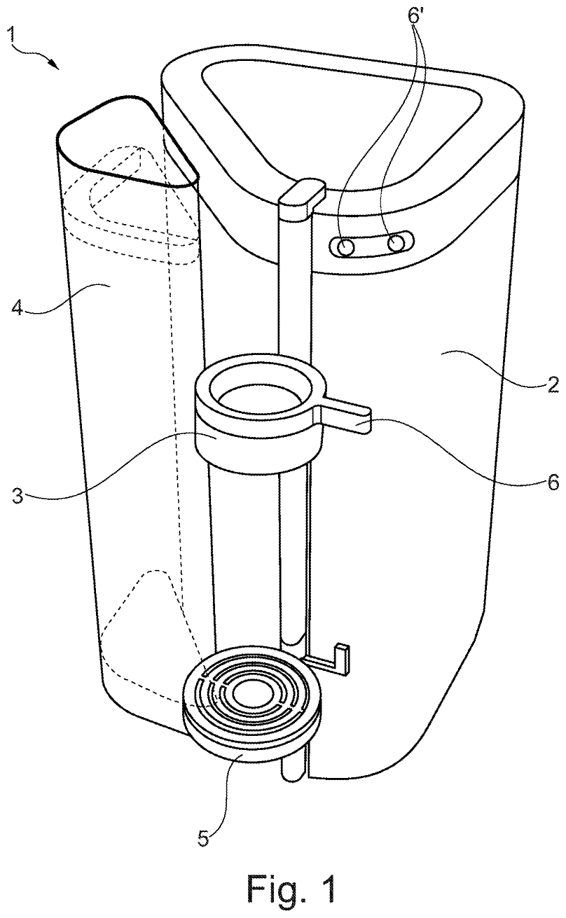

FIG. 1 illustrates a beverage preparation machine 1 according to a first exemplary embodiment of the present invention. The beverage preparation machine 1 comprises a main unit 2 with a housing in which most of the components required for operation are housed, as well as a liquid reservoir 4, here a water tank. As an alternative to the embodiment illustrated here, the liquid reservoir 4 can also be arranged at least partially in the housing, and/or the beverage preparation machine 1 has a connection to an external liquid supply system. In addition, the main unit 2 has some operating elements 6′ which can be actuated by a user and, for example, can initiate the, in particular automatic, beverage preparation procedure or process.

The beverage preparation machine 1 stands with a base element on a preferably as far as possible horizontal surface and has a certain overall height. In the present case, the main unit is flat at the top, but other shapes, for example rounded or pointed, are likewise possible. According to the embodiment illustrated here, a cartridge holder 3 protrudes laterally from the main unit 2 to approximately 60%-70% of the total height.

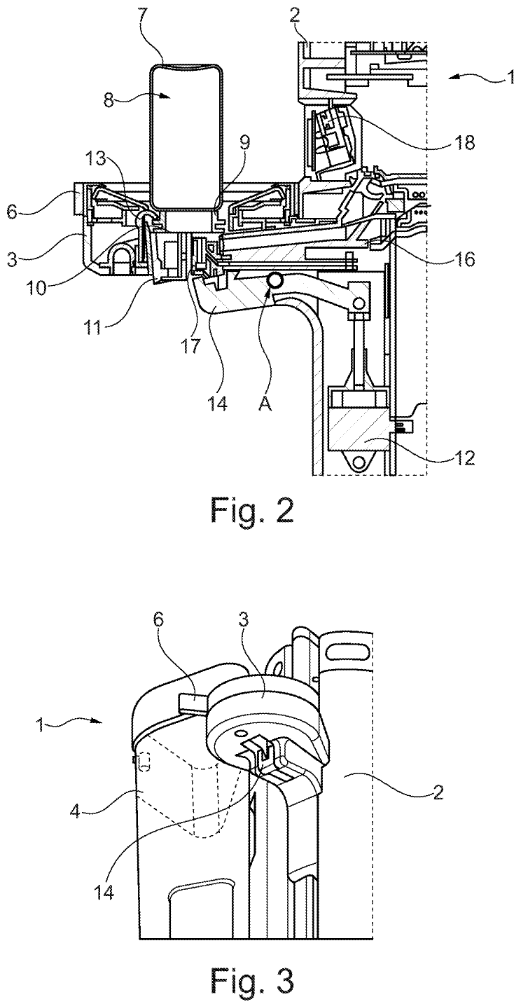

Here, the cartridge holder 3 has a round cross section in a horizontal plane and is of substantially disk-shaped design. Arranged below the cartridge holder 3 in a vertical direction is a set-down region 5, in which at least one drinking vessel can be set down. The set-down region 5 comprises a drip grid and/or a liquid collecting device. The cartridge holder 3 preferably has an aperture in the center, that is to say in particular a hole, into which a cartridge system can be inserted from above. Such a cartridge system is explained in more detail in conjunction with FIG. 2. The cartridge holder 3 has at least one locking means 13, here in the form of three claw-shaped elements distributed substantially uniformly around the circumference of the aperture. These elements are illustrated in FIG. 2.

After the user has inserted the cartridge system with the cartridge receptacle 11 first from above into the cartridge holder 3, they actuate the operating element 6, which is embodied here as a rotary lever. In the present case, the operating element 6 can be pivoted in an angular range of approximately 180° about an axis of rotation running centrally and vertically through the cartridge holder 3. Alternatively, the angular range is only 30°, 60°, 90° or 120°. By means of markings and/or inscriptions on the cartridge holder 3, it is preferably possible in this case for the user to see which position of the operating element 6 corresponds to an unlocked position and which position corresponds to a locked position. It is preferred here that the operating element 6 is coupled to the control device in such a way that it is only possible to start beverage preparation when the operating element 6 is in the locked position and/or a cartridge system has been inserted in the cartridge holder 3. It is likewise conceivable for beverage preparation to start automatically as soon as the operating element 6 has transferred the locking means 13 into the locked position.

FIG. 2 illustrates a cross section of a beverage preparation system according to one exemplary embodiment of the present invention. In this case, the embodiment of the beverage preparation machine 1 which is illustrated here corresponds substantially to the embodiment explained in conjunction with FIG. 1, for which reason reference is made to the explanations relating thereto. In the case illustrated here, a cartridge system is inserted into the cartridge holder 3 and the claw-type locking means 13 is already in the locked position, in which it, for example, by the operating element 6, which is rotatably mounted at the top on the outside and the lever-type extension of which is not situated in the cutting plane. Furthermore, an additional liquid outlet is illustrated at the bottom left. Such an additional liquid outlet is described in more detail in the applicant's application of the same filing date as the present application, entitled “Beverage preparation machine with a liquid outlet and beverage preparation system”. The statements in this regard, in particular with regard to the exact configuration of this liquid outlet, are hereby explicitly incorporated into the present disclosure.

The cartridge system comprises a cartridge 7 and a cartridge receptacle 11 connected to the cartridge in a connecting region, for example a neck region. The cartridge 7 comprises a reservoir 8, in which a preferably liquid beverage substance is contained. The cartridge 7 is preferably manufactured from a plastic material. Alternatively, however, it is also possible for the cartridge 7 to be manufactured at least partially from glass. As a particular preference, the cartridge 7 has at least one flange 9 or a flange region. Via this flange 9, the cartridge 7 is connected directly and indirectly, for example via an intermediate piece, to the cartridge receptacle 11, wherein the intermediate piece preferably provides a positive connection between the cartridge 7 and the cartridge receptacle 11, in particular in the form of an adapter. In the direction of the cartridge receptacle 11, the cartridge 7 has an opening which is closed by a sealing element, here a sealing film 10. As a particular preference, the locking means 13 engages positively and/or non-positively in the flange 9, thus preventing the cartridge system from being pulled out in the locked position of the locking means 13.

The cartridge receptacle 11 is fastened with an opening to the cartridge 7 and has in the interior a mixing chamber into which, on the one hand, the conditioned liquid from the beverage preparation machine 1 is introduced and into which, on the other hand, after actuation of a cartridge discharging device yet to be explained, the beverage substance can be transferred from the reservoir 8 of the cartridge 7. In the mixing chamber, the liquid and the beverage substance mix and thus form the beverage, which finally flows via a beverage outlet into a drinking vessel which can be arranged underneath. The cartridge discharging device preferably comprises a spike guide and a piercing spike 17 mounted so as to be displaceable therein in one direction.

The piercing spike 17 is shown here in a retracted position, i.e. the tip is at a distance from the sealing film 10, or at least the sealing film 10 has not yet been pierced. The cartridge holder 3 comprises an actuator element 14, which, after activation, transfers the piercing spike 17 into an extended position in which the sealing film 10 is pierced. As can be seen from the drawing, a compressed air line is integrated into the piercing spike 17. In the retracted position of the piercing spike 17, the latter is not connected. In the extended position, the compressed air line is aligned with a line in the cartridge receptacle 11 or directly with a compressed air line of the beverage preparation machine 1. Here, the beverage preparation machine 1 has a coupling element 16, which has two integrated and mutually separate lines, a liquid line and a compressed air line. The coupling element 16 can preferably be brought selectively into fluid communication with a cartridge receptacle 11 inserted in the cartridge holder 3. Further details both of the coupling element 16 and of the locking means 13 can be found in the applicant's application of the same filing date, entitled “Beverage preparation machine with a locking means and a coupling element, and beverage preparation system”. The statements in this regard, in particular with regard to the configurations of the locking means and/or of the coupling element (referred to there as coupling element), are explicitly incorporated into the present disclosure.

An identification detector 18, which here comprises an optical sensor, for example, is provided above the cartridge holder 3 in the housing of the main unit 2. This identification detector can detect an identification of the cartridge and/or of the cartridge receptacle in a manner known per se and forward the detected information to the control device. It is thus conceivable, for example, for starting of the beverage preparation process to be prevented if an unapproved identifier is detected.

Not shown here are the further components of the beverage preparation device, such as, for example, a compressed air source, which is provided for feeding compressed air via the coupling element 16 into the cartridge system, and a liquid conditioning system, which conditions a liquid, in particular water. This preferably comprises temperature control, for example cooling and/or heating, of the liquid and/or carbonating, i.e. adding carbonic acid to the liquid. Furthermore, the beverage preparation machine 1 comprises a fluid supply system which introduces the conditioned liquid and/or the compressed air from the liquid conditioning system or the compressed air source into the cartridge system. The coupling element 16 is, in particular, part of the fluid supply system.

According to the embodiment illustrated, the actuator element 14 is designed as a rocker lever which has a projection that interacts with the piercing spike 17 and can be pivoted about a tilting axis A. According to the invention, the actuator element 14 is now actuated by a drive 12, which is here arranged in the main unit 2. In this case, the drive 12 is, for example, an electric motor as a linear drive, i.e. the drive 12 generates a linear movement, in particular in the vertical direction.

A person skilled in the art understands that the desired direction of force is of outstanding importance as regards the design and selection of a drive 12. In the present case, the drive 12 operates in tension, i.e. when activated, an element connected to the actuator element 14, in this case the rocker lever, is moved vertically downward at its machine-side end. An upward movement of the end of the actuator element 14 on the cartridge holder side is therefore generated via the tilting axis, as a result of which the piercing spike 17 is transferred into the extended position. The piercing spike 17 consequently pierces the sealing film 10. In the extended position, the compressed air lines are aligned with one another, and therefore compressed air is introduced into the reservoir 8 via the piercing spike 17. There, the compressed air assists the transfer of the beverage substance into the mixing chamber. At the same time, the conditioned liquid is introduced into the mixing chamber.

FIG. 3 illustrates a perspective view of a cartridge holder 3 according to one exemplary embodiment of the present invention. In this case, the embodiment illustrated here corresponds substantially to the embodiments explained above, and therefore attention is drawn to the preceding explanations. Here, the cartridge holder 3 is shown obliquely from below. Clearly visible here, in particular, is the operating element 6, which is in the unlocked position or in an intermediate position here.

It is conceivable for the cartridge holder to be arranged so as to be vertically displaceable along a guide. As a particular preference, the cartridge holder can be latched at different heights. This enables drinking vessels of different heights to be used.

Furthermore, the liquid reservoir optionally comprises a filter means for preparing the liquid, in particular for descaling the water.

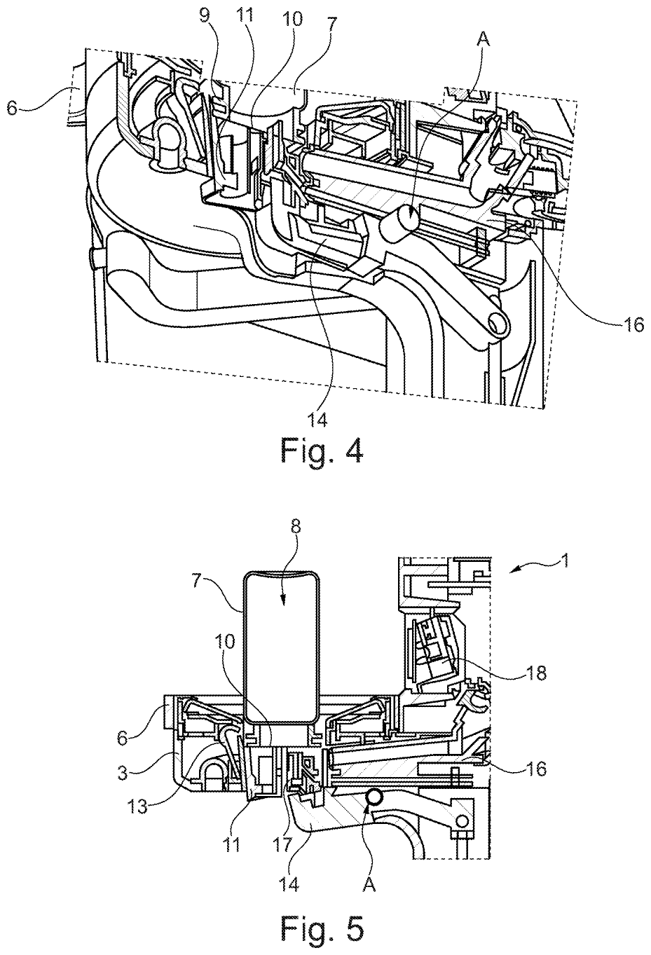

FIG. 4 illustrates a perspective sectional view of a cartridge holder 3 according to one exemplary embodiment of the present invention. In this case, the embodiment illustrated here corresponds substantially to the embodiments explained above, in particular the embodiment explained in conjunction with FIG. 2 and therefore attention is drawn to the preceding explanations. The actuator element 14 designed as a rocker lever is clearly visible here. Here, the piercing spike 17 is shown in the extended position, in which the sealing film 10 was pierced. In this case, the rocker lever is situated partially below the cartridge holder and extends partially into the housing of the main unit. Here, the tilting axis A is implemented by the actuator element 14 having pin-type extensions which are rotatably mounted in corresponding bearings of the beverage preparation machine 1, in particular of the cartridge holder 3. Alternatively, however, the reverse case is also conceivable, i.e. at least one axis penetrates the actuator element 14 at least partially (for example, two axes can also be provided, which engage in the actuator element on both sides) and optionally the actuator element 14 can be pivoted about the tilting axis A, wherein the axis is arranged in a rotationally fixed manner, or the axis, which is formed separately from the actuator element 14, is connected to the actuator element 14 for conjoint rotation therewith and rotates relative to the main unit 2.

FIGS. 5 to 7 illustrate a method for preparing beverages according to one exemplary embodiment of the present invention in various steps. In this case, the embodiment of the beverage preparation machine 1, the cartridge holder 3 and the cartridge system which is illustrated here corresponds substantially to the embodiments explained above, and therefore attention is drawn to the preceding explanations. In the following, it is, in particular, the differences between the various steps that are explained.

FIG. 5 illustrates the situation in which a user has inserted a cartridge system into cartridge holder 3, but the locking means 13 has not yet been transferred into the locked position. Here, the illustration is chosen to be very similar to that in FIG. 2, and therefore, particularly with regard to the other components, attention is drawn to the statements relating to these. As can be seen from the drawing, the aperture of the cartridge holder 3 is designed to taper downward. This ensures that the cartridge system can only be inserted into the cartridge holder 3 from above and is retained positively in the cartridge holder 3, i.e. in particular, it cannot fall downward out of the cartridge holder 3. The inner contours of the aperture of the cartridge holder 3 and the outer contours of the cartridge receptacle 11 are preferably designed to be complementary, thus facilitating a positive fit. In addition, the cartridge receptacle 11 and the aperture of the cartridge holder 3 deviate from a perfectly circular cross section, a flattened portion preferably being present, in particular in the region of the fluid supply or of the coupling element. In this way, on the one hand, the, in particular fluidtight, coupling of the coupling element 16 to the cartridge receptacle is simplified, and, on the other hand, it is ensured in a particularly advantageous manner that the cartridge system is correctly inserted into the cartridge holder 3, thereby avoiding incorrect operation.

The piercing spike 17 of the cartridge discharging device is still in the retracted position, and the sealing film 10 is still undamaged.

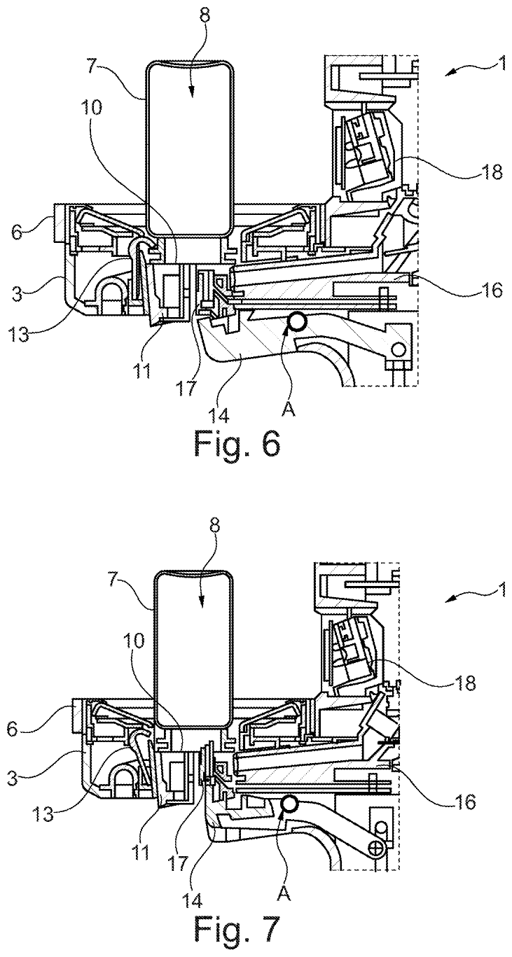

FIG. 6 now shows the locked position. For example, the user has rotated the operating element 6 and has therefore indirectly transferred the at least one locking means 13 into the locked position, in which the locking means 13 engages behind the flange 9 of the cartridge 7. The cartridge system can now no longer be removed from the cartridge holder 3; an accidental outflow of liquid from the beverage preparation machine 1 without a cartridge receptacle 11 is prevented in this way. As soon as it has received information that the locking means 13 is in the locked position and/or that the cartridge system has been correctly inserted in the cartridge holder 3, the control device preferably enables starting of beverage preparation via a further operating element 6′. Alternatively, beverage preparation can also start automatically. As mentioned above, the optional identification detector 18 can, for example, detect the insertion of a suitable cartridge system and/or receive preparation parameters and forward them to the control device.

In this context, preparation parameters are, for example, a liquid volume, a liquid temperature, a degree of carbonation, a speed of the liquid flow, a compressed air volume and/or a speed of the compressed air flow.

The coupling element 16 has been brought to the fluid supply of the cartridge receptacle 11 in a manner not explained in detail here, thus establishing a fluidtight connection of the compressed air line on the cartridge receptacle side to the compressed air line of the coupling element 16 and a fluidtight connection of the fluid supply on the cartridge receptacle side to the liquid line of the coupling element 16.

The control device can now determine the optimum time for transferring the beverage substance into the mixing chamber and control the drive, for example the electric motor, accordingly. The latter actuates the actuator element 14, which in turn contacts the piercing spike 17 and displaces it upward along the spike guide, with the result that the tip of the piercing spike 17 pierces the sealing film 10. The compressed air line integrated into the piercing spike is now in alignment with the compressed air line of the cartridge receptacle and/or the compressed air line of the coupling element 16, and therefore compressed air provided by the compressed air source can enter the reservoir and assists the transfer of the beverage substance through the hole in the sealing film 10 into the mixing chamber. After mixing with the liquid introduced into the mixing chamber, the beverage flows through the beverage outlet of the cartridge receptacle into the drinking vessel provided (or the liquid collecting device provided in the set-down region).

FIG. 7 now illustrates the situation after the end of beverage preparation. The piercing spike 17 is in the extended position, the locking means 13 has been transferred into the unlocked position, in particular by the user transferring the operating element 6 back into the unlocked position.

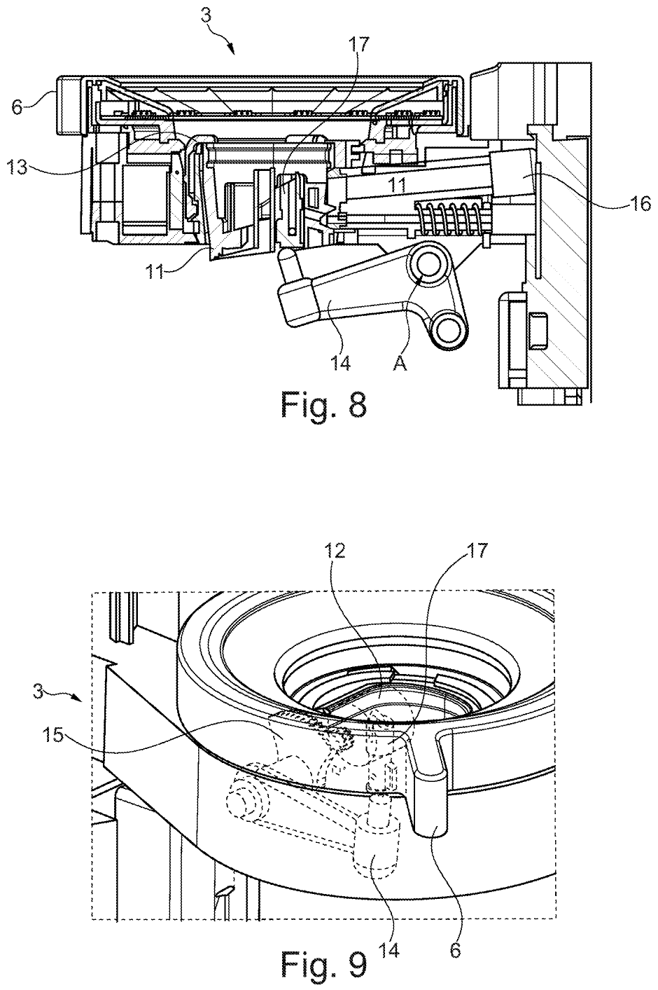

FIGS. 8 to 11 illustrate alternative embodiments of the drive 12 and/or of the actuator element 14 and, where applicable, deflection mechanisms 15 located between these elements. Here, the previous statements apply to the other components of the beverage preparation system.

FIG. 8 illustrates a schematic cross section of a cartridge holder 3 and of an actuator element 14 according to one exemplary embodiment of the present invention. Furthermore, a cartridge receptacle 11 inserted into the cartridge holder 3 can be seen but, for the sake of clarity, an illustration of the associated cartridge 7 has been dispensed with.

Here, the actuator element 14 is not designed as a longitudinally extended rocker lever, but as an angled rocker lever. At its tip, it has a tappet, the rounded surface of which interacts, preferably positively, with a correspondingly concavely shaped underside of the piercing spike 17. On the one hand, the angled shape allows the direction of force to be changed. A thrust in the direction of the cartridge holder, that is to say outward, in particular a substantially horizontal thrust, is now required in order to actuate the actuator element. Accordingly, the drive 12 in the main unit 2 can be positioned and/or designed differently. If, for example, a drive 12 as illustrated in FIG. 2 is to be used, a deflection mechanism 15 (not illustrated here) is required, which deflects the force provided by the drive 12 correspondingly to the actuator element 14 as an output. In the present case, a linear drive which operates with a thrust and, in the simplest case, is arranged horizontally in the main unit 2 is particularly suitable.

A person skilled in the art will understand that a multiplicity of different drives 12 can be used by the combination of the design of the actuator element 14 and a suitable deflection mechanism 15. In particular, a drive 12 suitable for the respective installation situation can be selected.

FIG. 9 illustrates a perspective view of an actuator element 14 and a drive 12 according to a further exemplary embodiment of the present invention. According to the embodiment illustrated here, the drive is a rotary drive, for example once again an electric motor, which drives the actuator element 14 via a deflection mechanism 15, here for example a transmission gear. As a result, only a small installation space is required, and therefore the drive 12, the deflection mechanism 15 and the actuator element 14 together can be arranged at least partially on the underside of the cartridge holder 3. Alternatively, the drive can also be arranged directly in the transition region between the cartridge holder 3 and the main unit 2. For the sake of clarity, only the piercing spike 17 of the cartridge system is illustrated.

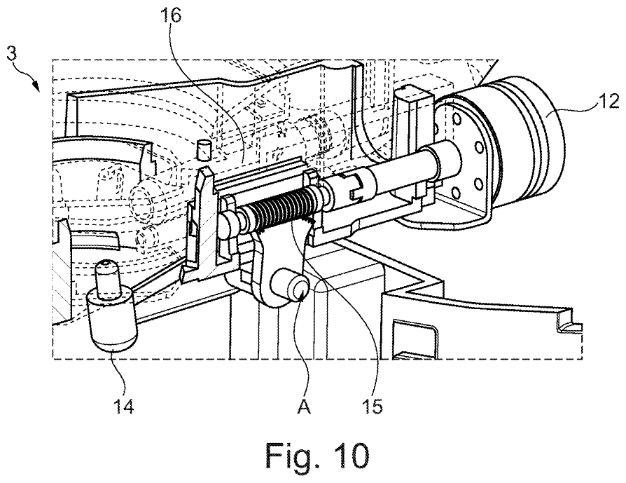

FIG. 10 illustrates a perspective view of an actuator element 14 and a drive 12 according to yet another exemplary embodiment of the present invention. Once again, the drive 12 can be designed here as a rotary drive and, in particular, as an electric motor. Here, the drive 12 is arranged in the main unit 2, which is only indicated in the drawing. The drive 12 is connected via a shaft to a deflection mechanism 15, which is designed here as a worm gear. This deflection mechanism 15 is in turn connected to the actuator element 14. In the present case, the drive 12 is arranged in the main unit 2, where as a rule more installation space is available than in the cartridge holder 3, although the drive 12 requires little installation space in the main unit by virtue of the embodiment illustrated. As a result of the combination of shafts and the worm gear, no translation takes place, and therefore no free space has to be provided into which elements can move. Moreover, the illustrated arrangement is possible even though the drive 12 and the actuator element 14 are situated on different horizontal planes. Rotation in one plane about a horizontally and longitudinally arranged axis of rotation is thus redirected into a rotation in a lower horizontal plane about the tilting axis oriented transversely to the axis of rotation and likewise horizontally.

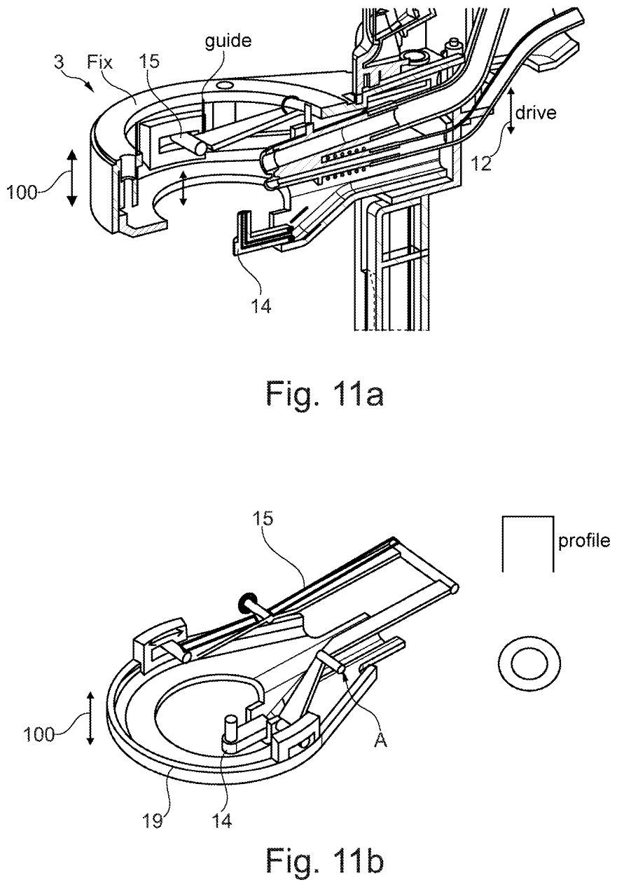

FIGS. 11a and 11b illustrate perspective views of an actuator element 14 according to a further exemplary embodiment of the present invention. For the sake of clarity, only the cartridge holder 3 is illustrated. In the present case, the drive 12 can be of identical design, for example, to the drive 12 explained in conjunction with FIG. 2, i.e. an electric motor which is arranged vertically in the main unit 2 and is designed as a linear drive. In this case, the deflection mechanism 15 comprises a lever which can be pivoted about a tilting axis A, wherein the drive 12 acts on the machine-side end of the lever and the other end is mounted in a longitudinally displaceable manner in a slotted guide of a vertically movably arranged plate-shaped element 19 of the cartridge holder 3. When the drive 12 is activated, a lower, movable, plate-shaped element 19 of the cartridge holder 3 is moved upward along the direction of movement 100 via the lever of the deflection mechanism 15. In this case, the actuator element 14 is fastened in fixed manner to this plate-shaped element 19 and is therefore likewise moved upward and thus activates the piercing spike 17 and transfers it from the retracted position into the extended position.

In other words, in this case a movable element 19 on the underside of the cartridge holder 3 is connected in a fixed manner to the actuator element 14 and, in contrast to the variants discussed above, the triggering movement here is a purely vertical translation 100. This is advantageous in comparison with pivoting of the actuator element 14 since, in this case, the orientation of the actuator element 14 and the piercing spike 17 relative to one another remains unchanged.

A person skilled in the art will understand that, in particular, the drives 12 and deflection mechanisms 15 discussed in FIGS. 2 and 8 to 11 can also be combined with one another, enabling a person skilled in the art to select the combination of deflection mechanism 15 and drive 12 which is suitable for the respective installation situation.

### LIST OF REFERENCE SIGNS

1 Beverage preparation machine
2 Main unit
3 Cartridge holder
4 Liquid reservoir
5 Set-down region
6, 6′ Operating elements
7 Cartridge
8 Reservoir
9 Flange
10 Sealing film
11 Cartridge receptacle
12 Drive
13 Locking means
14 Actuator element
15 Deflection mechanism
16 Coupling element
17 Piercing spike
18 Identification detector
19 Plate-shaped element
100 Direction of movement
A Tilting axis

1. A beverage preparation machine, in particular a dispenser, for preparing a beverage by means of a cartridge system, the beverage preparation machine comprising:
A) a main unit comprising:
a. a liquid reservoir;
b. a liquid conditioning system for conditioning a liquid from the liquid reservoir, in particular for controlling the temperature of and/or carbonating the liquid;
c. a fluid supply system for introducing the conditioned liquid and/or compressed air into the cartridge system; and
d. a control device for controlling the liquid conditioning system and/or the fluid supply system; and
B) a cartridge holder, which protrudes from the main unit and is of balcony-like design;
wherein the cartridge system consists of:
a) a cartridge, which has a beverage substance in a reservoir; and
b) a cartridge receptacle, which is connected to the cartridge and includes:
i) a mixing chamber;
ii) at least one fluid supply; and
iii) at least one beverage outlet;
wherein the cartridge holder is designed in such a way that the cartridge system can be inserted into it;
wherein the cartridge holder comprises an actuator element for actuating a cartridge discharging device of the cartridge system; and
wherein the main unit or the main unit and the cartridge holder comprises/comprise a drive for the actuator element.

2. The beverage preparation machine as claimed in claim 1, wherein the drive is a manual drive and/or a motor, wherein the drive is a linear drive, a rotary drive, and/or a vibratory drive.

3. The beverage preparation machine as claimed in claim 2, wherein the motor is an electric motor, a hydraulic motor, or a pneumatic motor.

4. The beverage preparation machine as claimed in claim 1, wherein the cartridge holder is of substantially disk-shaped design and protrudes substantially horizontally from the main unit, and wherein the cartridge holder has a substantially circular aperture into which the cartridge system can be inserted.

5. The beverage preparation machine as claimed in claim 1,
wherein the cartridge holder and/or the main unit has at least one operating element which can be actuated by a user and is coupled to the drive via the control device.

6. The beverage preparation machine as claimed in claim 5, wherein the operating element is a lever, which can be pivoted about a horizontally or vertically oriented axis.

7. The beverage preparation machine as claimed in claim 1, wherein the cartridge holder has at least one locking means, which is provided for reversibly locking the cartridge system in the cartridge holder, wherein the locking means can be transferred from an unlocked position into a locked position and vice versa.

8. The beverage preparation machine as claimed in claim 7, wherein the locking means can be transferred from the unlocked position into the locked position by an operating element.

9. The beverage preparation machine as claimed in claim 1, wherein the beverage preparation machine is configured in such a way that the actuator element and/or the drive can only be activated when the locking element is in a locked position.

10. The beverage preparation machine as claimed in claim 1, wherein the drive is connected to the actuator element via a deflection mechanism, wherein the deflection mechanism comprises a transmission gear and/or a transmission lever.

11. The beverage preparation machine as claimed in claim 1, wherein the actuator element is provided so as to be pivotable about at least one axis.

12. The beverage preparation machine as claimed in claim 1, wherein the actuator element is arranged at least partially below the cartridge holder.

13. The beverage preparation machine as claimed in claim 1, wherein the actuator element is a rocker lever, wherein the rocker lever has an upper contact surface for positive and/or nonpositive interaction with the cartridge discharging device of the cartridge system.

14. The beverage preparation machine as claimed in claim 1, wherein the beverage preparation machine comprises a compressed air source, wherein the compressed air source is provided for introducing compressed air into the cartridge system in interaction with the fluid supply system.

15. The beverage preparation machine as claimed in claim 1, wherein the beverage preparation machine has an identification detector for detecting an identification of the cartridge system.

16. A beverage preparation system having a beverage preparation machine as claimed in claim 1 and a cartridge system, wherein the cartridge system can be inserted into the cartridge holder of the beverage preparation machine for beverage preparation:
wherein the cartridge system comprises a cartridge, which comprises a reservoir filled with a beverage substance, and a cartridge receptacle, which can be connected to the cartridge in a connecting region;
wherein the cartridge has a cartridge opening, wherein the cartridge opening is closed by a sealing element, wherein the sealing element closes off the reservoir in a fluidtight manner with respect to the cartridge receptacle;
wherein the cartridge receptacle has a mixing chamber, which can be brought into fluid communication with the reservoir, and a fluid supply, which opens into the mixing chamber, for coupling to the fluid supply system of the beverage preparation machine, thus enabling a conditioned liquid to be introduced into the mixing chamber;
wherein the cartridge receptacle has a cartridge discharging device for transferring the beverage substance from the reservoir into the mixing chamber; and
wherein the cartridge receptacle has a beverage outlet for dispensing from the mixing chamber a beverage formed by mixing the liquid with the beverage substance.

17. The beverage preparation system as claimed in claim 16, wherein the cartridge discharging device comprises a spike guide and a piercing spike, which is mounted so as to be displaceable within the spike guide, wherein the piercing spike is displaceable by the actuator element of the beverage preparation machine between a retracted position, in which the piercing spike is at a distance from the sealing element, and an extended position, in which the piercing spike pierces the sealing element and projects into the reservoir.

18. The beverage preparation system as claimed in claim 17, wherein the cartridge discharging device comprises a compressed air connection and a compressed air line, which extends from the compressed air connection to a compressed air outlet, wherein the compressed air outlet protrudes, in a direction of the reservoir of the cartridge, wherein the compressed air connection is designed to introduce compressed air into the compressed air line, wherein the compressed air line is integrated into the piercing spike, wherein the cartridge discharging device is designed in such a way that, in the extended position of the piercing spike, the beverage substance can be transferred from the reservoir, into the mixing chamber by the compressed air.

19. A method for preparing a beverage with a beverage preparation system as claimed in claim 16, comprising the following steps:
a. inserting the cartridge system, which consists of a cartridge and a cartridge receptacle, into the cartridge holder,
b. establishing a fluid connection between the fluid supply system and the cartridge receptacle,
c. activating the actuator element to actuate the cartridge discharging device by transferring the piercing spike from the retracted position into the extended position, thereby bringing about perforation of the sealing element,
d. transferring the beverage substance from the reservoir of the cartridge into the mixing chamber of the cartridge receptacle by feeding compressed air into the reservoir,
e. introducing a conditioned liquid into the mixing chamber of the cartridge receptacle through the fluid supply system, and
f. discharging the beverage produced in the mixing chamber by mixing the beverage substance with the conditioned liquid through the beverage outlet.

20. The method as claimed in claim 19, wherein activating the actuator element comprises generating a relative movement between the cartridge receptacle and the actuator element, which is in contact with the piercing spike.
